(19) United States
(12) Patent Application Publication
(10) Pub. No.: US 2009/0106781 A1
(43) Pub. Date: Apr. 23, 2009

(54) Remote call handling methods and systems

(76) Inventors: Benjamin C. Reed, Morgan Hill, CA (US); Flavio P. Junqueira, Barcelona (ES)

Correspondence Address: BERKELEY LAW & TECHNOLOGY GROUP LLP, 17933 NW EVERGREEN PARKWAY, SUITE 250, BEAVERTON, OR, 97006, US

(21) Appl. No.: 11/877,417

(22) Filed: Oct. 23, 2007

(51) Int. Cl. G06F 13/00

(52) U.S. Cl. 719/330

(57) ABSTRACT

Methods and apparatuses are provided for handling remote calls, for example, in a servicing system having a plurality of operatively coupled service instances, wherein a request is received by a service instance which identifies the request as being associated with a non-state-changing operation or a state-changing operation. When the operation is identified as being non-state-changing then request may be processed by the receiving service instance. When the operation is identified as being state-changing then request may also be provided to and processed by other service instances.

### BACKGROUND

1. Field

The subject matter disclosed herein relates to distributed processing, and more particularly to remote call handling methods and systems.

2. Information

Distributed processing techniques may be applied to provide robust computing environments that are readily accessible to other computing platforms and like devices. Systems, such as server farms or clusters, may be configured to provide a service to multiple clients or other like configured devices.

A Remote Procedure Call (RPC) protocol may be used in such systems to allow a client to invoke a remote operation. Historically, RPCs involve a single client and a single server, or more specifically, a service provided by a single server.

As the size of servicing systems has grown to encompass many servers the size and load of the network services have also grown. It is now common for network services to span multiple servers for availability and performance reasons.

Since RPCs may invoke an operation that changes the state of the system, state replication protocols may be used to keep the servers that make up a service synchronized with regard to the state of the system. These state replication protocols tend to maintain the consistency of shared data of the system and/or broadcast state changes initiated by a given server to all of the servers.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a block diagram illustrating an exemplary computing environment system, in accordance with one aspect, having one or more computing platform devices configurable to provide a servicing system that includes a plurality of like service instances each of which are capable of handling remotely generated requests.

FIG. 2 is a functional block diagram illustrating certain features that may be implemented in one or more exemplary computing platform devices, such as, for example, as shown in FIG. 1, to provide at least one service instance configurable to handle remote calls.

FIG. 3 is a flow diagram illustrating an exemplary remote call handling method that may be implemented, for example, using one or more devices such as shown in FIG. 1.

### DETAILED DESCRIPTION

Several exemplary techniques for handling remote calls are described and shown herein. These techniques may be implemented, for example, in a servicing system having a plurality of operatively coupled service instances that are part of a distributed processing environment. These techniques may, for example, allow for the use of remote procedure calls (RPCs) to service instances. Furthermore, these techniques may, for example, allow the service instances within the servicing system to maintain state information without the use of a centralized state replication protocol.

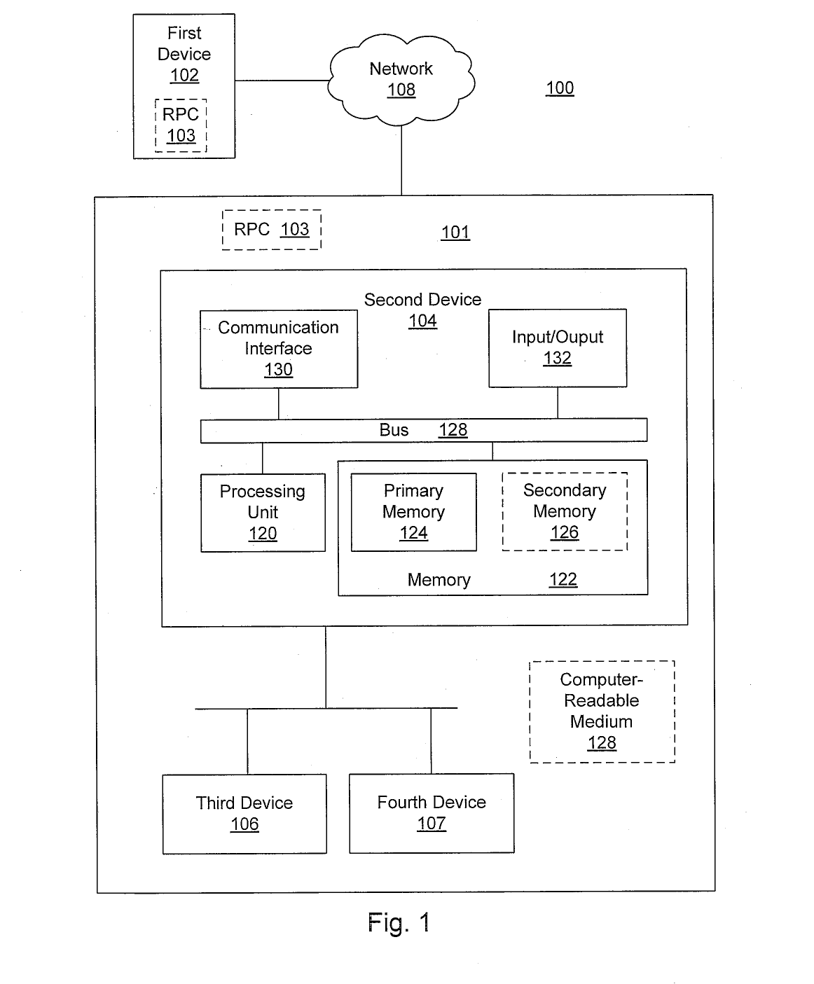

FIG. 1 is block diagram illustrating an exemplary implementation of a computing environment system 100 that may include one or more devices configurable to operate using remote calls. By way of example, but not limitation, such remote calls may conform to, be adapted to be similar to, or otherwise be based on, a protocol such as Remote Procedure Call (RPC) protocol or the like, which allow for devices in separate address spaces to operate together.

System 100 may include a servicing system 101 that is operatively coupled to a first device 102, here, e.g., through a network 108. In certain implementations, for example, first device 102 may include a client device and servicing system 101 may include one or more server devices.

As illustrated, within servicing system 101 there may be one or more computing system platforms. For example, servicing system 101 may include a second device 104, a third device 106 and a fourth device 107, each of which are further operatively coupled together. In this example, second device 104 may be the same type of device or a different type of device than third device 106 and/or fourth device 107. With this in mind, in the examples that follow, only second device 104 is described in greater detail in accordance with certain exemplary implementations.

Further, it should be understood that first device 102, second device 104, third device 106, and fourth device 107, as shown in FIG. 1, are each representative of any device, appliance or machine that may be configurable to exchange data over network 108. By way of example but not limitation, any of these devices may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet based service provider/system, a portal and/or search engine service provider/system, a wireless communication service provider/system; and/or any combination thereof.

Similarly, network 108, as shown in FIG. 1, is representative of one or more communication links, processes, and/or resources configurable to support the exchange of data between at least two of first device 102, second device 104, third device 106, and fourth device 107. By way of example but not limitation, network 108 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

It is recognized that all or part of the various devices and networks shown in system 100, and the processes and methods as further described herein, may be implemented using or otherwise include hardware, firmware, software, or any combination thereof.

Thus, by way of example but not limitation, second device 104 may include at least one processing unit 120 that is operatively coupled to a memory 122 through a bus 128.

Processing unit 120 is representative of one or more circuits configurable to perform at least a portion of a data computing procedure or process. By way of example but not limitation, processing unit 120 may include one or more processors, controllers, microprocessors, microcontrollers, application specific integrated circuits, digital signal processors, programmable logic devices, field programmable gate arrays, and the like, or any combination thereof.

Memory 122 is representative of any data storage mechanism. Memory 122 may include, for example, a primary memory 124 and/or a secondary memory 126. Primary memory 124 may include, for example, a random access memory, read only memory, etc. While illustrated in this example as being separate from processing unit 120, it should be understood that all or part of primary memory 124 may be provided within or otherwise co-located/coupled with processing unit 120.

Secondary memory 126 may include, for example, the same or similar type of memory as primary memory and/or one or more data storage devices or systems, such as, for example, a disk drive, an optical disc drive, a tape drive, a solid state memory drive, etc. In certain implementations, secondary memory 126 may be operatively receptive of, or otherwise configurable to couple to, a computer-readable medium 128. Computer-readable medium 128 may include, for example, any medium that can carry and/or make accessible data, code and/or instructions for one or more of the devices in system 100.

Second device 104 may include, for example, a communication interface 130 that provides for or otherwise supports the operative coupling of second device 104 to at least network 108. By way of example but not limitation, communication interface 130 may include a network interface device or card, a modem, a router, a switch, a transceiver, and the like.

Second device 104 may include, for example, an input/output 132. Input/output 132 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 132 may include an operatively configured display, speaker, keyboard, mouse, trackball, touch screen, data port, etc.

With regard to system 100, in certain implementations first device 102 may be configurable, for example, to generate and transmit a request associated with a procedure or other like operation that servicing system 101 may provide. For example, one such request may take the form of or be adapted from an RPC protocol 103 illustrated as being operatively associated with servicing system 101 and first device 102.

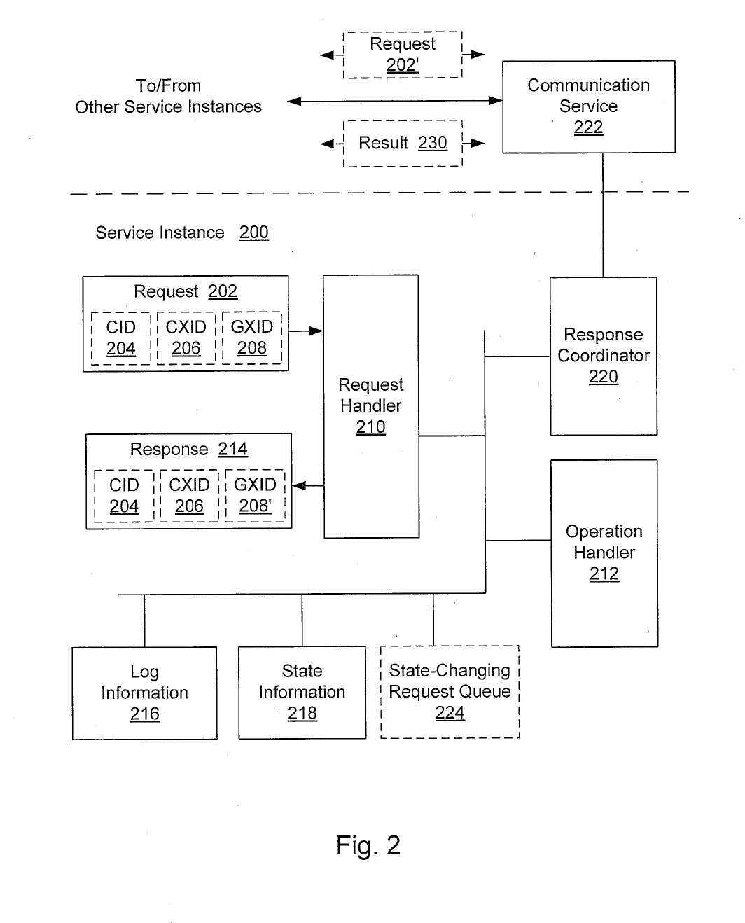

Reference is now made to FIG. 2, which is a functional block diagram illustrating certain features that may be implemented in one or more exemplary computing platform devices of servicing system 101 to provide at least one service instance 200 configurable to handle remote calls.

Service instance 200 may include, for example, a request handler 210 that is configurable to receive or otherwise access a request 202 and provide or otherwise make available a response 214 associated with the processing of request 202. Request 202 may, for example, be generated by first device 102 and provided to servicing system 101 via network 108.

Request handler 210 is operatively coupled to an operation handler 212 that is configurable to perform at least a portion of at least one operation associated with request 202 or other requests, such as, for example, state-changing requests in queue 224 (e.g., described in greater detail below).

Operation handler 212 may, for example, be operatively configured to access (e.g., read and/or write) state information 218. State information 218 may include any information in the form of data associated with one or more states of service instance 200, servicing system 101, and/or other information that may be associated with the operation(s) thereof. State information 218 may be provided in a memory. Request handler 210 may also access state information 218.

Note that while certain features are illustrated as being operatively coupled in the drawings, it is recognized that other operative couplings may also be provided and/or that some may be eliminated in certain implementations.

In this example, request handler 210 is further illustrated as being operatively coupled to log information 216. In certain implementations, log information 216 may, for example, be included in state information 218. Log information 216 may include, for example, previously generated responses, requests, or other like information. Similarly, state-changing request queue 224 which is illustrated as being operatively coupled to response coordinator 220 may be included in state information 218. Log information 216 and state-changing request queue 224 are described in greater detail in later sections.

As shown in FIG. 2, response coordinator 220 may be operatively coupled to a communication service 222. Communication service 222 may be configurable to provide communication between the plurality of service instances in servicing system 101. For example, as illustrated, communication service 222 may be configured to allow response coordinators within service instances to exchange data, such as, a request 202′ and/or a result 230.

The dashed line separating communication service 222 from service instance 200 represents that in certain implementations communication service 222 may be a supporting service within servicing system 101.

In accordance with an aspect of the methods and systems provided herein, request 202 is generated by an external device and received or otherwise accessed by request handler 210. Request 202 may include, for example, data identifying one or more operations that are requested to be preformed by servicing system 101. In certain implementations, for example, request 202 may include a client identifier (CID) 204, a client request identifier (CXID) 206, and/or a global request identifier (GXID) 208. Similarly, response 214 may include, for example, data identifying one or more operations that were preformed by servicing system 101. In certain implementations, for example, response 214 may include a client identifier (CID) 204, a client request identifier (CXID) 206, and/or a global request identifier (GXID) 208′. Some exemplary uses for such identifiers are described in greater detail in later sections.

Request hander 210 identifies or otherwise determines if an operation (or at least one operation) associated with request 202 is state-changing or non-state-changing.

As used herein, a non-state-changing operation is one that, when performed, should not change or otherwise affect the state of servicing system 101. An example of a non-state-changing operation would be a remote procedure call requesting the “time” as defined by servicing system 101. When such non-state-changing operation is performed state information 218 should not change or otherwise be affected as a result of the operation. Another example of a non-state-changing operation would be a request for a bank account balance. Here, for example, the non-state-changing operation should not change or otherwise affect state information 218 relating to the bank account balance. Thus, non-state-changing operations may be performed by individual service instances without affecting the state of servicing system 101.

To the contrary, a state-changing operation is one that, when performed, changes or in some manner affects the state of service system 101. An example of a state-changing operation would be a request to change the “time” as defined by servicing system 101. Here, such a change in the time will presumably affect the state of servicing system 101. Hence, this change in state should be provided to the remaining service instances such that all of the service instances deal with the same applicable state information 218.

In accordance with certain aspects, rather than implementing additional logic that synchronizes state information across the service instances, the methods and systems provided herein may be configurable such that each service instance individually performs the same state-changing operations in the same order and at least initially each service instance may be configurable to start with the same applicable state information. Thus, the applicable state information 218 in each service instance should eventually be the same. Since such service instances may be operating asynchronously with respect to one another, state-changing operations may be queued and performed in order by each service instance.

By way of further example, one state-changing operation may be to withdraw funds from a bank account. The withdrawal would seem to change the state of servicing system 101 and hence it may be identified as a state-changing operation. Further, it seems certain that such a state-changing operation should only be performed one time. In accordance with one aspect of the methods and systems provided herein, the initial service instance 200 that receives and accepts such a request may be configured to not only perform the state-changing operation but to also forward or otherwise direct the request and/or state-changing operation to each of the other service instances. Thus, each of the service instances will eventually perform the state-changing operation and as such each should have the same applicable state information 218.

Moreover, in certain implementations, the initial service instance 200 may receive or otherwise access at least some if not all of the results from the other service instances and verify or otherwise compare such result(s) to its own “local” result from the state-changing operation before generating a response. In certain implementations, service instances may verify or otherwise associate results to requests, for example, to map results from different service instances to one or more requests.

With regard to the example shown in FIG. 2, when the operation is identified as being non-state-changing, service instance 200 may handle the request without affecting the other service instances. Thus, for example, request handler 210 may provide or otherwise make available all or part of the request to operation handler 212 to initiate the non-state-changing operation(s). Operation handler 212 may, for example, complete the requested non-state-changing operation(s) and provide or otherwise make available a result to request handler 210. Request handler 210 may then generate or otherwise make available a response 214 that may then be transmitted or otherwise provided to the requesting device.

Request handler 210 may update log information 216, for example, based on the receipt of request 202, and/or generation or successful transmission of response 214. For example, log information 216 may include all or part of request 202, response 214 or other information associated with the handling of the request.

When the operation is identified as being state-changing, request handler 210 may provide or otherwise make available all or part of the request to response coordinator 220 to initiate the broadcast or otherwise dissemination of the requested state-changing operation(s) to the other service instances. Here, for example, response coordinator 220 may initiate the broadcasting or forwarding of request 202 (or 202′) to each of the other service instances by communications service 222.

Request handler 210 may also provide or otherwise make available all or part of the request to operation handler 212 to initiate “local” state-changing operation(s). Operation handler 212 may, for example, complete the requested state-changing operation(s) and provide or otherwise make available a local state-changing result to request handler 210.

Response coordinator 220 may be further configurable to receive state-changing results (e.g., result 230) back from one or more of the other service instances, for example, via communication service 222. One or more of these state-changing results may then be provided to or otherwise made available to request handler 210. Request handler 210 may, for example, compare or otherwise process such state-changing result(s) with the local state-changing result (e.g., to verify that at least a threshold number of the state-changing results are the same).

Request handler 210 may then generate or otherwise make available response 214 (e.g., a final response) based, at least in part, on one or more of the state-changing results and/or the local state-changing result. Response 214 may then be transmitted or otherwise provided to the requesting device. Request handler 210 may update log information 216 and state information 218 based on the request 202 and/or response 214 being so provided.

As illustrated in the above example, each service instance 200 may receive state-changing requests from other service instances. Such state-changing requests may, for example, be arranged or otherwise managed using a state-changing request queue 224 or the like such that the state-changing requests are processed in the correct order (e.g., a temporal order). Hence, once all of the correctly functioning service instances have processed all of the state-changing requests the arrived at state information 218 should match (e.g., each should place servicing system 101 in the same state).

In the example illustrated in FIG. 2, response coordinator 220 may, for example, receive or otherwise access state-changing requests 202′ from other service instances via communication service 222. Such state-changing requests may be arranged, for example, in queue 224 (or otherwise maintained and scheduled in some manner by communication service 222). Request handler 210 may provide such state-changing requests (in proper order) to or otherwise initiate processing of the applicable state-changing operations (in proper order) by operation handler 212. Operation handler 212 may provide a results (e.g., in proper order) from the performed state-changing operations to request handler 210. Request handler 210 may then provide such results (e.g., in proper order) to response coordinator 220. Response coordinator 220 may then provide such results (e.g., in proper order) to communication service 222, which may then forward the results 230 to one or more other service instances as or if desired. Request handler 210 and/or operation handler 212 may (in proper order) update state information 218 as applicable.

In certain implementations, rather than using queue 224 (or in addition to using queue 224) communication service 222 may, for example, be configurable to ensure that each service instance receives each state-changing request in the proper order.

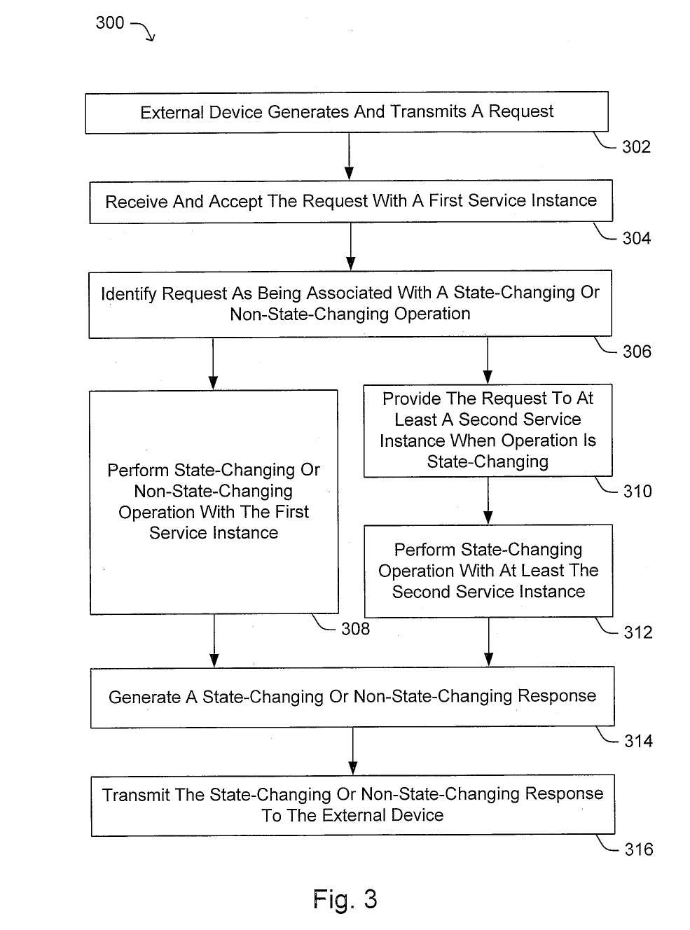

Reference is now made to FIG. 3, which is a flow diagram illustrating an exemplary remote call handling method 300 that may be implemented, for example, using one or more devices such as shown in FIG. 1.

In 302, one or more external devices may generate and transmit a request. In 304, the request may be received with a first service instance, which may selectively accept the received request.

For example, a client device may connect to a service instance on a server device, generate an RPC request and transmit the RPC request to the service instance. The service instance may, for example, be selected from among a plurality of service instances by chance or random selection, or based on some scheme.

The service instance may selectively accept the connection or request based on various factors. For example, a service instance may be configurable to only accept requests for which the state information of the service instance appears to be current with respect to the request or otherwise ready for such a request. For example, a request may include information that identifies a previous state or last interaction that the client had with the servicing system. By way of example but not limitation, a new request may include one or more identifiers, timestamps, or the like, from a previous request response or other exchange that may allow the service instance to determine the state that the servicing system was previously in. If the state of the service instance is not current with regard to the servicing system state, then it may not yet accept the request. In other words, the service instance may need to be brought “up-to-date” with regard to the state of the servicing system before it accepts new requests, especially state-changing requests.

In certain implementations, a service instance may accept a request but the processing of the request may need to wait until the service instance is up to date with regard to the state of the servicing system. For example, a service instance may be considered up to date with regard to the state of the servicing system if all state-changing operations or requests have been performed and/or “completed” in some manner (e.g., a response successfully transmitted/received, log information updated, etc.).

If the request was accepted in 304, then in 306 the request may be identified as being associated with a non-state-changing operation or a state-changing operation. Regardless of identification made in 306, in 308 the first service instance may perform the operation associated with the request. If the identification made in 306 is that the operation is state-changing, then in 310 the request may be provided to at least a second service instance, which may then, in 312, perform the state-changing operation. In 314, a non-state-changing response may be generated based on the result from the non-state-changing operation performed in 308, or a state-changing response may be generated based on one or more of the results of the state-changing operation performed 308 and/or 312. In 316, the non-state-changing or state-changing response may be transmitted to the one or more external devices.

In 314, for example, a state-changing response may be generated once a quorum or other like threshold number of service instances have responded with the same results. If the results from one or more some service instances disagree, then there may be an error in one or more service instances and/or their state information.

Some further features and examples will now be described in accordance with certain additional aspects of the exemplary methods and systems provided herein associated with recovering from service disrupts or disconnects.

Returning to the example in FIG. 1, if the network connection between first device 102 and second device 104 fails for some reason, then first device 102 may attempt to reconnect to a new service instance. The new service instance may be provided by second device 104 or other devices. Here, in this example, it will be assumed that the new service instance is provided by third device 106.

When first device 102 reconnects to the new service instance it may attempt to resend a pending request (e.g., an earlier request for which a response was not successfully received). If the request is identified as being associated with a non-state-changing operation, then the new service instance may proceed to perform the non-state-changing operation and generate a response. In certain implementations, if the non-state-changing request had been previously performed by the service instance, then request handler 210 may simply identify the earlier response in log information 216 and provide such rather than having operation handler 212 repeat the non-state-changing operation and/or duplicate the response.

If the request is associated with a state-changing operation, then the new service instance may verify that a response has not already been generated based on log information 216 and/or state information 218. For example, duplication may be avoided or substantially avoided based on the use of one or more unique or substantially unique identifiers such as, for example, a CID, a CXID, a GXID, a timestamp, and the like, or any combination thereof.

By way of further example but not limitation, to handle reconnects and detect duplicate requests all requests, responses, results, and/or other like applicable messages may include a CID, a CXID and a GXID. A CID 204, for example, may identify a client generating the request and may be included in at least request 202 and response 214. A CXID 206, for example, may identify the specific request (e.g., RPC request) generated by a client and may be included in at least request 202 and response 214. A GXID 208 or 208′, for example, may be added to all or some requests, responses, results, and/or other like applicable messages by service instance 200 and/or by communication service 222.

As illustrated in FIG. 2, request 202 may include a GXID 208 that the client previously received from the servicing system and response 214 may include a GXID 208′ that is more recent and associated with the request to which the response is being made. Thus, the “older” GXID 208 (and/or other identifiers) may allow the service instance to determine how to respond to the request or whether to accept such request.

In certain exemplary implementations, for example, the GXID may be a globally unique (or substantially unique) monotonically increasing identifier that may added by response coordinator 220 or communication service 222 (e.g., as part of a messaging layer (not shown)) to state-changing requests 202′ that are provided to the other service instances. In certain implementations, therefore, it may be that only requests, results and/or responses associated with state-changing operations may have a GXID.

In certain other implementations, request handler 210 may, for example, be configurable to add a GXID to each response 214 that is provided to a client (e.g., first device 102). In certain implementations, service instance 200 may be configured to only accept requests from a client if the service instance is “up to date”, e.g., by having information associated with GXID 208 in log information 216 or state information 218.

In certain implementations, CID 204 and CXID 206 may be paired together so as to allow service instance 200 to detect previously processed requests from a client, e.g., based on having information associated with the pair in log information 216 or state information 218.

In certain implementations, the saving of state information and/or log information may be accomplished in accordance with a schedule or the like. In certain implementations, for example, the saving of state information and/or log information may be associated with a starting or ending point associated with the receipt, handling, processing, response, result, or other like accomplishment. In certain implementations, for example, in saving of state information and/or log information a service instance may stop momentarily the service to avoid problems in the case of failures. In certain implementations, a callback scheme may be implemented as an affirmation procedure.

By way of example but not limitation, if the local state is saved automatically, service instance 200 may be configurable to provide callbacks to other processes indicative of the start and finish of the save operation. Thus, for example, request handler 210 may issue a start callback that causes response coordinator 220 and/or operation handler 212 to momentarily suspend servicing requests. During this suspended processing period state information and/or log information may be saved or otherwise processed in some manner. In certain implementations, the log information may be moved to or otherwise incorporated in state information 218. When request handler 210 subsequently issues a finished callback, servicing of requests may once again proceed and, if applicable, new log information 216 may be started.

In certain implementations, for example, requests may be logged for recovery purposes. Thus, if service instance 200 fails, as part of the recovery process, the restarted service instance may replay the requests that have been processed to return to a state that existed prior to the failure. Rather than always replaying a full log of requests against some initial state, in certain implementations the state may be periodically saved. As such, once the state is saved a new log file may be initiated and during a recovery the last saved state may be re-initiated and then the most recent log file played against it.

Since the service state may, for example, be maintained by application specific logic in operation handler 212 and memory, operation handler 212 may initiate or otherwise trigger a saving of state. In certain implementations, request handler 210 may be informed, for example by operation handler 212, when operation handler 212 starts to save a state and subsequently when operation handler has finished saving a state.

When a service instance restarts it may locate the most recent saved state and restore itself based on such. The service instance may, for example, need to reprocess (e.g., replay) one or more requests in the log information that occurred subsequent to the last saved state. Here, for example, the request handler and/or response coordinator may check the logged responses verses the logged requests to determine which requests to replay.

In certain implementations, a timestamp and random number seed may be included in the messages between service instances. Thus, for example, when a local service instance needs a random number or needs to get the time, the message timestamp and random seed may be used rather than local clocks or other random number sources. Consequently, all of the service instances may use the same time and random values when processing requests.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising:
receiving a request with a first service instance selected from among a plurality of operatively coupled service instances;
identifying said request as being associated with a non-state-changing operation or a state-changing operation;
processing said non-state-changing operation with said first service instance; and
processing said state-changing operation with said first service instance and at least a second service instance selected from among the plurality of operatively coupled service instances.

2. The method as recited in claim 1, wherein said request is associated with a Remote Procedure Call (RPC) protocol.

3. The method as recited in claim 1, wherein processing said state-changing operation further comprises:
providing said request to at least said second service instance.

4. The method as recited in claim 3, wherein processing said state-changing operation further comprises:
generating a response to said request using said first service instance based, at least in part, on said processing of said state-changing operation by said first service instance and at least said second service instance.

5. The method as recited in claim 4, wherein generating said response further comprises:
verifying that results from at least said processing of said state-changing operation by said first service instance and at least said second service instance are the same.

6. The method as recited in claim 3, wherein providing said request to at least said second service instance further comprises:
associating said request with a state-changing request identifier.

7. The method as recited in claim 6, further comprising:
generating a response to said request using said first service instance, wherein said response identifies said state-changing request identifier.

8. The method as recited in claim 1, wherein said request comprises at least one identifier selected from a group of identifiers comprising a requester identifier, a requester request identifier, and a most recent state-changing identifier.

9. The method as recited in claim 8, wherein receiving said request further comprises:
selectively accepting said request based, at least in part, on a comparison of a first service instance current system state with at least said most recent state-changing identifier.

10. The method as recited in claim 1, further comprising:
selectively identifying a first service instance current system state based, at least in part, on a state-changing identifier following completion of said processing said state-changing operation by said first service instance.

11. The method as recited in claim 10, further comprising:
storing said first service instance system state;
subsequently logging requests associated with at least said state-changing operation; and, as needed,
re-establish said first instance based, at least in part, on said stored first service instance system state and said logged requests.

12. The method as recited in claim 1, further comprising:
processing a plurality of state-changing operations associated with a plurality of received responses with at least said second service instance according to an order associated with said plurality of received responses; and
uniquely identifying each of said plurality of state-changing operations with at least a state-changing request identifier.

13. A computer program product, comprising computer-readable medium comprising instructions for causing at least one processing unit to:
provide a first service instance associated with a servicing system having
a plurality of operatively coupled service instances;
selectively receive a request for an operation;
perform said operation to produce a first instance result;
identify said request to at least a second service instance within said servicing system when said operation comprises a state-changing operation;
access at least a second instance result provided by said second service instance; and
generate a response to said request based, at least in part, on at least one result selected from a group of results comprising said first instance result and said second instance result.

14. The computer program product as recited in claim 13, wherein said request is associated with a Remote Procedure Call (RPC) protocol.

15. The computer program product as recited in claim 13, further comprising instructions for causing said at least one processing unit to:
verify that at least said first instance result and said second instance result are the same.

16. The computer program product as recited in claim 13, further comprising instructions for causing said at least one processing unit to:
associate said request with a state-changing request identifier; and
include said state-changing request identifier in said response.

17. The computer program product as recited in claim 16, further comprising instructions for causing said at least one processing unit to:
store a first service instance system state;
log requests associated with at least said state-changing operation; and, as needed,
re-establish said first instance based, at least in part, on said stored first service instance system state and said logged requests.

18. An apparatus for use in a servicing system, the apparatus comprising:
at least one processing unit adapted to:
access a request for at least one servicing system operation, perform said request and establish a result, and
in response to said servicing operation being a state-changing operation provide said request for processing by at least one other apparatus in said servicing system and receive there from a further result, and
establish a response based on at least one of said result and said further result.

19. The apparatus as recited in claim 18, wherein said request is associated with a Remote Procedure Call (RPC) protocol.

20. The apparatus as recited in claim 18, wherein said at least one processing unit is further adapted to verify that at least said result and said further result are the same.

21. The apparatus as recited in claim 18, wherein said at least one processing unit is further adapted to associate said request with a state-changing request identifier.

22. The apparatus as recited in claim 18, wherein said at least one processing unit is further adapted to:
store a system state associated with said servicing system and subsequently log at least requests for servicing system operations that are state-changing operations, and, as needed, re-adapt said apparatus based, at least in part, on said stored system state and said logged requests.

23. A servicing system comprising:
one or more computing platforms providing a plurality of service instances and a communication service operatively coupling said service instances,
wherein at least a first service instance is adapted to receive a request to perform an operation from an external computing platform and in response thereto:
in response to said operation being non-state-changing, locally perform said operation and generate a response based, at least in part, on a corresponding result of said operation, and
in response to said operation being state-changing, identify said request to remaining ones of said plurality of service instances via said communication service, locally perform said operation to produce a corresponding local result, receive at least one non-local result from at least one of said remaining ones of said plurality of service instances, and provide a final response based, at least in part, on at least one result selected from among said local result and said at least one non-local result.

24. The system as recited in claim 23, wherein said request is associated with a Remote Procedure Call (RPC) protocol.

25. The system as recited in claim 23, wherein in response to said operation being state-changing said request is associated with a state-changing request identifier and said state-changing response includes said state-changing request identifier.
